(19) United States
(12) Patent Application Publication
(10) Pub. No.: US 2012/0170211 A1
(43) Pub. Date: Jul. 5, 2012

(54) ACCESSORY FOR HAND HELD TABLET COMPUTER

(76) Inventors: Christian Waller, Naples, FL (US); Eric Waller, Naples, FL (US)

(21) Appl. No.: 12/984,357

(22) Filed: Jan. 4, 2011

(51) Int. Cl. G06F 1/16; A45F 5/00

(52) U.S. Cl. 361/679.56; 294/137

(57) ABSTRACT

An ergonomically improved handle for a tablet computer includes a handheld body and a recess in the body. The handheld body is sized for substantially complete retention in a user's hand. The recess in the body forms a receptacle having opposing surfaces spaced from each other a predetermined distance.

### BACKGROUND OF THE INVENTION

The present invention relates to tablet computers. More specifically, the invention relates to a device for holding a tablet computer to ease user strain and increase user comfort when holding the tablet computer.

### RELATED ART

The recent introduction of hand held tablet computing devices, such as the Apple iPad® and the Amazon Kindle® have provided users with highly portable devices that can be used to store information, view and read materials, play games, read e-mail, and surf the web. Many users of these devices are using them for increasingly lengthening periods of time. However, these devices can be uncomfortable for the user to hold for any extended periods of time; further, they can be difficult to firmly or securely hold for many users. The manufacturers of the devices attempt to make them as light as possible, and also as thin, or compact as possible, while maintaining a maximum or optimal viewing size. Because each device has its own fixed size, users each having of varying hand size, may find it uncomfortable or unsecure to hold the device. Hand strain also is a common problem with these devices, because a user holding the device is maintaining a fixed distance between his fingers and thumb while applying a constant pressure to maintain the device in a viewing position.

While it is common to hold the device with two hands while viewing or reading, other more interactive tasks, such as searching the web or composing an e-mail message, necessitate holding the device in one hand and touching, tapping, dragging, pinching, and/or pointing with the free hand. While it is possible to lay the device flat on its back while performing these operations, a flat surface is not always available, and back or neck stain are common problems with standing over the device to view it at a substantially vertical viewing direction. Thus, it is desirable to hold the device upright, but also be able to do so with a single hand. As noted above, devices are designed to be lighter, but prolonged use will still result in hand or wrist strain.

Many critics of tablet devices have pointed to the ergonomic shortcomings of tablet devices as the reason they may never be accepted in the mainstream.

Thus, there is a need in the art for an accessory for existing tablet devices that allows a user to securely and comfortably hold a tablet device with minimal user strain, especially over prolonged periods of time.

There also is a need in the art for a device for holding a tablet computer that is adaptable to hold the tablet in any preferred orientation. Furthermore, there is a need in the art for a device for holding a tablet computer that can be customized for each user.

### SUMMARY OF THE INVENTION

In one aspect of the invention, an ergonomically improved handle for a tablet computer includes a handheld body and a recess in the body. The handheld body is sized for substantially complete retention in a user's hand. The recess in the body forms a receptacle having opposing surfaces spaced from each other a predetermined distance.

In another aspect of the invention, an assembly comprising includes a tablet computer and a handle. The tablet computer has a front, a back, and a peripheral edge. The handle is selectively attachable to the tablet computer at a position about the peripheral edge of the tablet computer. The handle includes a handheld body sized for substantially complete retention in a user's hand and a recess in the body forming a receptacle having opposing surfaces. Each of the opposing surfaces contacts one of the front and the back of the tablet computer.

An understanding of these and other aspects and features of the present invention may be had with reference to the attached figures and following description, in which the present invention is illustrated and described.

### BRIEF DESCRIPTION OF THE DRAWING FIGURES

FIG. 1A is a perspective view of a preferred embodiment of the invention;

FIG. 1B is a side view of the embodiment of the invention shown in FIG. 1A;

FIG. 2 is a perspective view of the holding device of FIG. 1 in use with a tablet computer;

FIG. 3A is a perspective view of another embodiment of the holding device according to the invention; and

FIG. 3B is a side view of the embodiment of the holding device shown in

FIG. 3A.

### DETAILED DESCRIPTION OF THE INVENTION

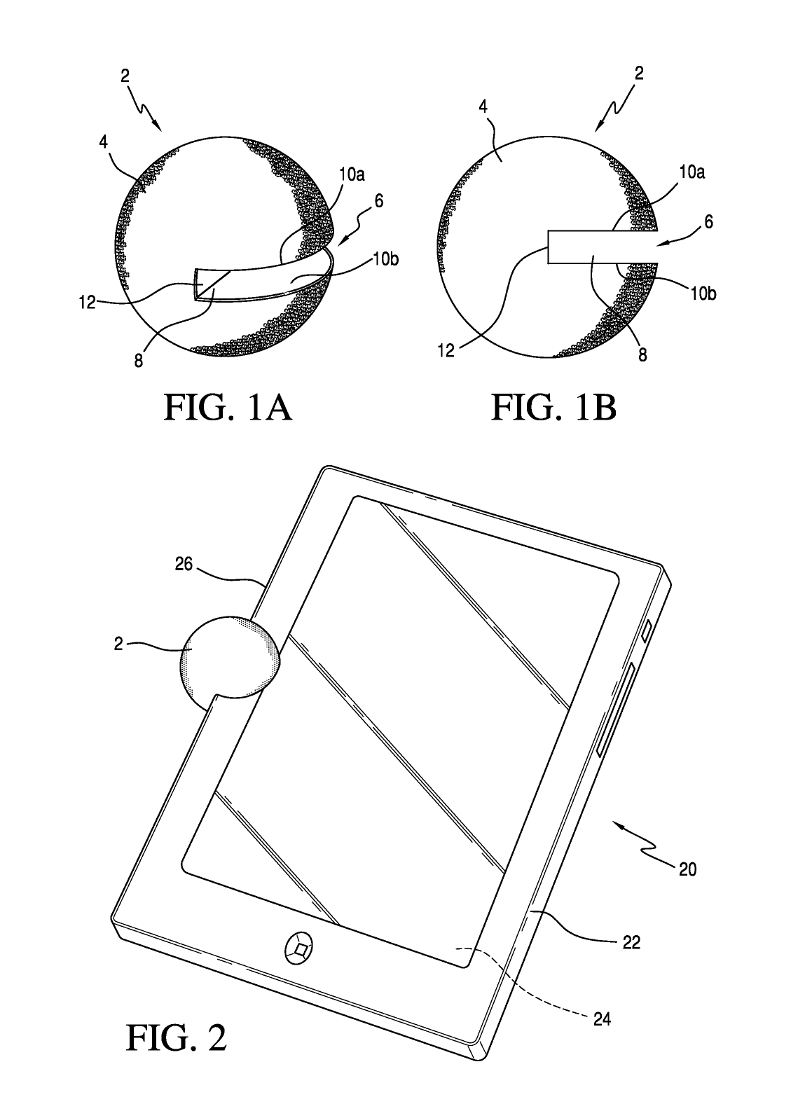

The present invention relates to an accessory for a tablet computing device. More specifically, the invention relates to a handle or holder for a tablet computing device that eases user strain associated with holding the device for prolonged periods of time at an inclined position that is most favorable to viewing and using the tablet computing device. FIG. 1 illustrates a holding device 2 according to a preferred embodiment of the invention. In FIGS. 1A and 1B, the holding device 2 includes a body 4 and a recess 6 in the body 4. The recess forms a receptacle 8 having opposing surfaces 10a, 10b, spaced from each other a predetermined distance.

The body is sized to be retained in a user's hand. That is, the holding device is hand held for a user.

As illustrated in FIG. 2, the opposing surfaces 10a, 10b are sized to receive therebetween a tablet computer 20. The tablet computer 20 includes a front surface 22, a back surface 24 and a peripheral edge 26. When the holding device 2 is applied to the tablet computer 20, one of the opposing surfaces 10a, 10b contacts the front surface 22 of the tablet computer 20 and the other of the opposing surfaces 10a, 10b contacts the back surface 24 of the tablet computer 20. The tablet computer 20 is thereby retained between the opposing surfaces 10a, 10b. A back wall 12 (shown in FIG. 1A) between the opposing surfaces 10a, 10b in the receptacle 8 may also contact the peripheral edge 26.

The holding device 2 may be retained on the tablet computer 20 in a number of different ways. In a first example, the opposing surfaces 10a, 10b are separated a predetermined distance that is substantially the same as or greater than the distance between the front surface 22 and the back surface 24 of the tablet computer 20. According to this example, the receptacle 8 readily receives the tablet computer 20 therein when the peripheral edge 26 slides between the opposing surfaces 10a, 10b. In use, the user applies a gripping force to the body 4 of the holding device 2, which force is transferred through the opposing surfaces 10a, 10b to apply a pressure to the front and back surfaces 22, 24 of the tablet computer 20. Accordingly, the user, when gripping the body of the holding device 2, can pick up or otherwise hold the tablet computer 20 without actually contacting the tablet computer 20. The gripping force retains the tablet computer in the holding device 2.

In another example of retaining the holding device 2 on the tablet 20, the opposing surfaces 10a, 10b may be spaced a distance that is substantially the same as or less than the distance between the first surface 22 and the back surface 24 of the tablet computer 20. Accordingly, a user must separate the opposing surfaces to place the receptacle 8 over the peripheral edge 26 of the tablet computer 20. This separation may be achieved by physically contacting the two opposing surfaces and pulling them apart a sufficient distance to allow reception of the tablet computer 20 in the receptacle 8. Alternatively, the opposing surfaces may be separated by applying a force to opposing sides of the body 4.

In such an embodiment, the force applied to separate the opposing surfaces 10a, 10b is substantially parallel to planes coincident with the opposing surfaces 10a, 10b.

The ability to separate the opposing surfaces 10a, 10b requires that the body 4 have sufficient pliability to allow for such separation. Preferably, the body is made of a rubber, plastic or composite material, although any material could be used. When a force is no longer applied to separate the opposing surfaces 10a, 10b, they preferably return to their normal position. Accordingly, when the tablet computer is disposed within the receptacle 8, a pressure is applied by the opposing surfaces 10a, 10b of the receptacle 8, by virtue of the opposing surfaces attempting to return to their normal position. In this embodiment, the user may be required to exert less pressure on the holding device 2 to pick-up or otherwise hold the tablet computer 20.

Moreover, when the tablet computer 20 is set down or is otherwise not being used by the user, the holding device will maintain its position on the tablet computer 20. This may be beneficial to avoid losing the holding device. Furthermore, when the holding device 2 is maintained on the tablet computer 20 when not in use, it may be easier for the user to pick up the tablet computer because it is not laying flat on a surface. This may also help to protect the back of the tablet computer 20 from contacting debris, spills, or other potentially hazardous materials that the tablet computer would otherwise be placed in. As a further advantage, when the holding device is placed on the top edge of the tablet computer, the computer, when placed on a flat surface, will remain inclined for easier viewing by the user.

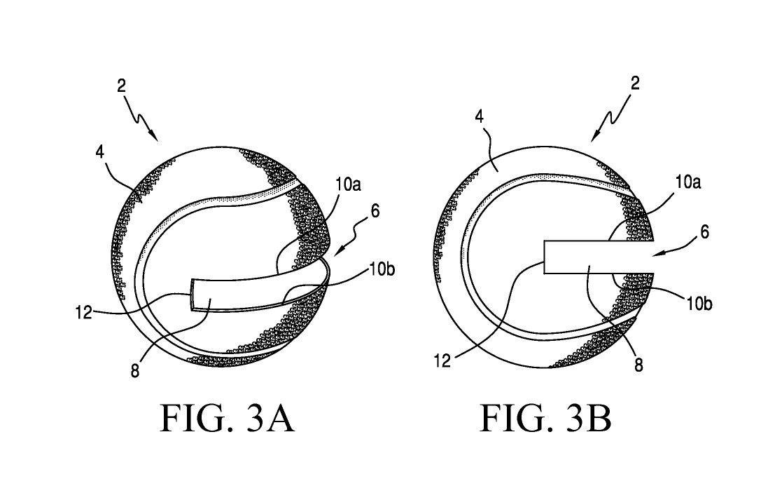

As illustrated in the figures, the body 4 is substantially spherical. However, this is not required. The body 4 may take any shape or size, for example, tailored to a particular user. Moreover, for marketing purposes, the body 4 may be shaped to represent some other object. In one example, illustrated in FIG. 3, the body 4 could be shaped like a tennis ball. Other sports balls also could be used, such as footballs, basketballs, or baseballs. In another embodiment, the body 4 could be shaped like a company logo such as an apple. Also for marketing and for customization purposes, the body 4 could include some indicia formed thereon such as the name and or logo of a sports team, a company name, or the like. The indicia could be printed directly on the body 4, or could be applied using an adhesive or the like, as a sticker or a skin. The body 4 also may be shaped so as to include contours such as contours that allow the body 4 to be more readily received by a user's hand. These contours may include indentations for fingers or thumbs.

In the example of FIGS. 1A and 1B, the opposing surfaces 10a, 10b are generally shown as being planar surfaces. However, this is not required for the operation of the device, and the invention is not limited to this embodiment. In another embodiment, one or both of the surfaces may be only a thin wall, as shown in FIGS. 3A and 3B, as opposed to a complete surface comprising an entire side of the receptacle 8. In FIGS. 3A and 3B, the body 4 may be hollow and thus comprise only a thin wall. In this embodiment, the cross-section of the thin wall would be the opposing surfaces 10a, 10b. Alternatively, only a portion of the body 4 may be hollow such that only one of the opposing surfaces 10a, 10b comprises the cross-section of the wall of the body, while the other opposing surface 10a, 10b is a planar surface occupying substantially all of that side of the receptacle 8. Based on this disclosure, other combinations will be readily appreciated by those of ordinary skill in the art.

The opposing surface 10a, 10b are also shown in FIGS. 1 and 1B as being smooth surfaces. This is not required. For example, the surfaces may be contoured or otherwise non-planar. In one embodiment, one or both of the opposing surfaces could be ribbed, knurled, or include protrusions. In these embodiments, the opposing surfaces 10a, 10b may be enhanced to provide a greater gripping area. For example, the ribs, knurls, or protrusions could be formed of a more malleable material that would enhance the grip of the holding device 2 on the tablet computer 20.

It may also be desirable to vary the first and second surfaces, due to the design of the tablet computer. For example, in a tablet computer that includes a glass screen as the front surface 22, it may be desirable to spread any gripping force maintaining the holding device 2 on the tablet computer 20 over a greater area, thus reducing the pressure at any point on the screen, to avoid breaking. Alternatively, if the portion of the front surface 22 or the back surface 24 to be contacted is metal, dispersion of the gripping force will be less of a concern.

Although in the preferred embodiment of the invention, the opposing surfaces, 10a, 10b are substantially identical, it may be desirable to form the body such that one of the opposing surfaces 10a, 10b protrudes further than the other of the opposing surfaces 10a, 10b. For example, it may be desirable to have the opposing surface 10a, 10b that contacts the back surface 24 of the tablet computer 20 protrude further on the tablet computer 20 than the other of the opposing surfaces 10a, 10b, which contacts the front surface 22. In this way, the bottom surface may accommodate a user's outstretched finger, and it may provide a larger surface area over which a pressure created by the weight of the tablet computer is distributed. Moreover, when the opposing surface contacting the front surface 22 of the tablet computer 20 is smaller, it will have less potential to obstruct viewing of the tablet computer's display.

In embodiments of the invention, the opposing surfaces 10a, 10b define a footprint that is within the footprint of the body 4. That is, the receptacle 8 is preferably disposed within the outer surface of the body 4. When a gripping force is to be applied by a user to hold the tablet computer using the holding device 2, that force is applied to the outer surface of the body substantially within a footprint of the opposing surfaces 10a, 10b. That is, the force applied by the user between his fingers and his thumb is directly through the opposing surfaces 10a, 10b and through the portion of the tablet computer retained within the receptacle 8. Thus, holding and gripping the tablet computer with the holding device 2 is similar to that conventionally done but the holding device 2 creates much less strain on the users hand and wrist.

In the illustrated embodiments, a single holding device 2 is illustrated as being used in connection with a tablet computer 20. The holding device 2 is readily removable from the tablet computer 20 such that it can be placed at any number of positions along the peripheral edge of the tablet computer 20. Preferably, the holding device 2 can be placed anywhere along the peripheral edge of the tablet computer 20, according to a user's preference. Thus, the holding device is readily useable by right handed users and left handed users, and at horizontal and vertical orientations of the tablet computer. Moreover, more than one holding device 2 may be provided, for example, for a user who desires to hold the tablet computer with two hands.

Other embodiments and alterations of the holding device 2 also are envisioned. For example, the holding device 2 may include a hole or other receptacle for receiving a pointing or selecting device, which may be used in connection with the tablet computer.

While in the preferred embodiment, the holding device is selectively attachable to the tablet to be positioned in any number of positions on the tablet, it may alternatively be affixed to the tablet. For example, adhesive or some mechanical means may be used to fix the holding device to the tablet computer. In such an embodiment, the user need not apply a pressure to maintain the holding device on the tablet computer. Instead, the holding device acts merely as a handle for more comfortable holding of the tablet.

As discussed above, in several embodiments, it is preferable that the device have some malleability or flexibility. However, this is not required. The device may be made of any number of materials including, but not limited to plastics, rubbers, synthetics, fabrics, wood, foam, or virtually any other material. Moreover, the device may be made of a combination of two or more those materials.

Moreover, the device may be made in any number of sizes. Such varying sizes would be useful to allow the invention to be used by any user with varying hand sizes.

In one preferred embodiment of the invention, the holding device is a unitary device. However, it may be formed of two or more components that are later assembled.

The foregoing embodiments of the present invention are provided as exemplary embodiments and are presently best modes for carrying out the invention. Modifications of these embodiments will be readily apparent to those of ordinary skill in the art. The invention is not intended to be limited by the foregoing embodiments, but instead is intended to be limited only by the appended claims.

1. A handle for a device comprising:
a handheld body sized for substantially complete retention in a user's hand; and
a recess in the body forming a receptacle having opposing surfaces spaced from each other a predetermined distance.

2. The handle of claim 1, wherein the opposing surfaces are biasable relatively closer to each other to impart a gripping pressure on a device placed between the opposing surfaces.

3. The handle of claim 2, wherein the gripping pressure is applied to the body by the user on an outer surface of the body proximate the opposing surfaces.

4. The handle of claim 2, wherein the gripping pressure is applied to the body by the user on a portion of an outer surface of the body within a footprint of the opposing surfaces.

5. The handle of claim 1, wherein the opposing surfaces are biasable away from each other to separate the opposing surfaces from the predetermined distance.

6. The device of claim 1 wherein the opposing surfaces are substantially parallel.

7. The device of claim 1, further comprising indicia on an outer surface of the body.

8. The device of claim 1, wherein at least one of the opposing surfaces includes a gripping surface.

9. An assembly comprising:
a tablet computer having a front, a back, and a peripheral edge; and
a handle selectively attachable to the tablet computer at a position about the peripheral edge of the tablet computer, the handle comprising a handheld body sized for substantially complete retention in a user's hand and a recess in the body forming a receptacle having opposing surfaces, each of the opposing surfaces contacting one of the front and the back of the tablet computer.

10. The assembly of claim 9, wherein a gripping pressure applied to the body by a user maintains the opposing surfaces of the receptacle in contact with the front and the back of the tablet computer.

11. The assembly of claim 9, wherein the opposing surfaces of the receptacle are normally biased toward each other to maintain the handle on the tablet computer.

12. The assembly of claim 9, wherein at least one of the opposing surfaces further includes a gripping surface.

13. The assembly of claim 12, wherein the gripping surface is one of a rib, a knurl, and a protuberance.

14. The assembly of claim 9, wherein the body is hollow.

15. The assembly of claim 11, wherein the force applied by the user is to an outer surface of the body and is directed through the opposing surfaces and the tablet computer.
